(19) United States
(12) Patent Application Publication
(10) Pub. No.: US 2010/0208576 A1
(43) Pub. Date: Aug. 19, 2010

(54) RECORDING DEVICE AND RECORDING METHOD FOR DUAL LAYER RECORDING DISC

(76) Inventors: Hidehiro Ishii, Tokorozawa-shi (JP); Takashi Hora, Tokorozawa-shi (JP); Nobuo Haino, Tokorozawa-shi (JP); Mutsumi Kono, Tokorozawa-shi (JP); Yuichi Tanaka, Tokorozawa-shi (JP)

Correspondence Address: YOUNG & THOMPSON, 209 Madison Street, Suite 500, Alexandria, VA, 22314, US

(21) Appl. No.: 11/911,852

(22) PCT Filed: Apr. 19, 2006
(86) PCT No.: PCT/JP2006/308193

§ 371 Date: Oct. 18, 2007

(51) Int. Cl. G11B 3/70

(52) U.S. Cl. 369/283; G9B/3.103

(57) ABSTRACT

In a first recording process, an end position of a kth cell (62) is aligned with an end position (P6) of a first layer recording area (43) by adjusting a recording start position (P5) of contents data (61) in an unused area (R1) in the first layer recording area (43). In a second recording process, an mth cell over the layers is divided into two cells, and the cells are recorded in an end area of the first layer recording area (43) and the head area of the second layer recording area (46), respectively.

### TECHNICAL FIELD

The present invention relates to a recording apparatus and a recording method which allow content data to be recorded onto a dual-layer recording disk, i.e. an optical disk having two recording layers.

### BACKGROUND ART

DVDs are widely spread as optical disks which can record information at high density. The DVDs include a read-only type DVD, a write-once type DVD, and a rewritable type DVD. The read-only type DVD includes a DVD having one layer with information recorded, or a DVD having two layers with information recorded. Moreover, the dual-layer type DVD includes a single-sided dual-layer type and a double-sided dual-layer type.

Currently, a single-layer write-once type DVD is widely spread. The single-layer write-once type DVD has a recording capacity of 4.7 GB. On the single-layer write-once type DVD, content data including, e.g., about two-hour video images and audio can be recorded.

On the other hand, currently, there is spread a DVD recorder which is equipped with: a disk drive apparatus, which records information onto the single-layer write-once type DVD or the rewritable type DVD; and a recording apparatus provided with a large-recording capacity (e.g. several tens to several hundreds GB) recording medium, such as a hard disk drive apparatus. According to this DVD recorder, it is possible to encode a video signal and an audio signal about a television program, which is transmitted from, e.g., a television broadcast station, in accordance with a DVD video standard and record them onto the large-capacity recording medium, such as a hard disk. Moreover, according to the DVD recorder, it is possible to dub or copy the content data, which is already encoded and which is recorded on the large-capacity recording medium, such as a hard disk, onto the single-layer write-once type DVD.

### DISCLOSURE OF INVENTION

### Subject to be Solved by the Invention

By the way, lately, a single-sided dual-layer write-once type DVD (hereinafter referred to as a “dual-layer write-once type DVD”) has been developed. The dual-layer write-once type DVD has a larger recording capacity than that of the single-layer write-once type DVD. The dual-layer write-once type DVD is expected to realize the continuous recording of the content data, which is longer than the content data that can be recorded onto the single-layer write-once type DVD. For example, it is expected to continuously dub or copy the long and encoded content data, which is recorded on the large-capacity recording medium, such as a hard disk, over the first layer and the second layer of the dual-layer write-once type DVD, by providing a disk drive apparatus, which records the information onto the dual-layer write-once type DVD, for the aforementioned DVD recorder in which the large-capacity recording apparatus is built, such as a hard disk drive apparatus.

However, there is such a problem that it is hard to continuously record such long and encoded content data over the first layer and the second layer of the dual-layer write-once type DVD in compliance with the DVD video standard.

For example, if the encoded content data is simply recorded over the first layer and the second layer of the dual-layer write-once type DVD, in some cases, a cell is recorded over the first layer and the second layer. This is against the DVD video standard. That is, the content data encoded in accordance with the DVD video standard is divided into data blocks which are reproduction units, i.e. cells. Then, the content data is recorded into the recording area on the DVD in such a state that it is divided into the cells. On the DVD video standard, the cells need to be physically continuously recorded in the recording area of the DVD. Thus, it is not allowed that the cell is recorded over the layers of the dual-layer write-once type DVD.

Thus, in order to prevent the cell from being recorded over the layers, there is a possible method of recording the cell up to the tail of the recording area in the first layer and recording the next cell from the head of the recording area in the second layer. According to this method, however, in some cases, an unrecorded area is left in the tail portion of the recording area in the first layer. Moreover, some data, which does not influence the reproduction, needs to be recorded in the unrecorded area, at the latest before a finalize process is completed with respect to the dual-layer write-once type DVD. If some data is recorded into the unrecorded area, another data is inserted between the last content data that is recorded in the recording area in the first layer and the first content data that is recorded in the recording area in the second layer, wherein the another data is different from the last content data and the first content data. Thus, there is a possibility that the DVD video standard is violated again from a different point of view. Moreover, depending on the content of the inserted data, there is a possibility that nothing is displayed on a screen immediately before a layer change, a noise is displayed on the screen, or no sound is produced, when the content data is reproduced.

As described above, it is not easy to continuously record the encoded content data over the first layer and the second layer of the dual-layer write-once type DVD in compliance with the DVD video standard.

On the other hand, if the DVD video standard is not followed and a unique recording method is employed, it is released from the restriction that the cell is not to be recorded over the layers, or the like. Thus, it may be easier to continuously record the encoded content data over the first layer and the second layer. However, if the unique recording method is employed, it is hardly possible to provide compatibility with competitors' products with regard to the recording and reproduction of the content data.

In order to solve the above-exemplified problems, it is therefore an object of the present invention to provide a recording apparatus, a recording method, and a computer program, which can continuously record the encoded content data over the first layer and the second layer of the dual-layer recording disk in compliance with the DVD video standard.

### Means for Solving the Object

The above object of the present invention can be achieved by a first recording apparatus for recording encoded content data, which is divided into n data blocks (n is an integer of 2 or more), over two layers of a dual-layer recording disk, the recording apparatus provided with: a recording start position determining device for determining a recording start position of the content data in an unused area in a recording area of the first layer such that a tail position of the k-th data block (k is an integer of 1 or more, and k<n), counted from a head of the content data, matches a tail position of the recording area of the first layer when the content data is recorded into the unused area in the recording area of the first layer of the dual-layer recording disk; a first layer recording device for recording a portion of the content data, which is from the head of the content data to the k-th data block, from the recording start position in the unused area in the recording area of the first layer; a layer changing device for changing the recording area in which the content data is to be recorded, from the recording area of the first layer of the dual-layer recording disk to a recording area of the second layer; and a second layer recording device for recording a remaining portion of the content data into the recording area of the second layer.

The above object of the present invention can be also achieved by a second recording apparatus for recording encoded content data, which is divided into n data blocks (n is an integer of 2 or more), over two layers of a dual-layer recording disk, the recording apparatus provided with: a dividing device for dividing the m-th data block (m is an integer of 1 or more, and m≦n) into a former portion and a latter portion, forming a first specified data block by using the former portion of the m-th data block, and forming a second specified data block by using the latter portion of the m-th data block such that a tail position of the former portion of the m-th data block, counted from a head of the content data, matches a tail position of a recording area of the first layer when the content data is recorded into an unused area in the recording area of the first layer of the dual-layer recording disk; a first layer recording device for recording a portion of the content data, which is from the head of the content data to the (m−1)-th data block, and the first specified data block into the unused area in the recording area of the first layer; a layer changing device for changing the recording area in which the content data is to be recorded, from the recording area of the first layer of the dual-layer recording disk to a recording area of the second layer; and a second layer recording device for recording the second specified data block and a remaining portion of the content data into the recording area of the second layer.

The above object of the present invention can be also achieved by a third recording apparatus for recording encoded content data, which is divided into n data blocks (n is an integer of 2 or more), over two layers of a dual-layer recording disk, the recording apparatus provided with: a dummy data block inserting device for inserting a dummy data block between the (j−1)-th data block and the j-th data block (j is an integer of 1 or more, and j n), which is expected to be recorded over the layers of the dual-layer recording disk when the content data is recorded into an unused area in a recording area of the first layer of the dual-layer recording disk; a first layer recording device for recording a portion of the content data, into which the dummy data block is inserted and which is from a head of the content data to the dummy data block, into the unused area in the recording area of the first layer; a layer changing device for changing the recording area in which the content data is to be recorded, from the recording area of the first layer of the dual-layer recording disk to a recording area of the second layer; and a second layer recording device for recording a remaining portion of the content data into the recording area of the second layer.

The above object of the present invention can be also achieved by a first recording method of recording encoded content data, which is divided into n data blocks (n is an integer of 2 or more), over two layers of a dual-layer recording disk, the recording method provided with: a recording start position determining process of determining a recording start position of the content data in an unused area in a recording area of the first layer such that a tail position of the k-th data block (k is an integer of 1 or more, and k<n), counted from a head of the content data, matches a tail position of the recording area of the first layer when the content data is recorded into the unused area in the recording area of the first layer of the dual-layer recording disk; a first layer recording process of recording a portion of the content data, which is from the head of the content data to the k-th data block, from the recording start position in the unused area in the recording area of the first layer; a layer changing process of changing the recording area in which the content data is to be recorded, from the recording area of the first layer of the dual-layer recording disk to a recording area of the second layer; and a second layer recording process of recording a remaining portion of the content data into the recording area of the second layer.

The above object of the present invention can be also achieved by a second recording method of recording encoded content data, which is divided into n data blocks (n is an integer of 2 or more), over two layers of a dual-layer recording disk, the recording method provided with: a dividing process of dividing the m-th data block (m is an integer of 1 or more, and m≦n) into a former portion and a latter portion, forming a first specified data block by using the former portion of the m-th data block, and forming a second specified data block by using the latter portion of the m-th data block such that a tail position of the former portion of the m-th data block, counted from a head of the content data, matches a tail position of a recording area of the first layer when the content data is recorded into an unused area in the recording area of the first layer of the dual-layer recording disk; a first layer recording process of recording a portion of the content data, which is from the head of the content data to the (m−1)-th data block, and the first specified data block into the unused area in the recording area of the first layer; a layer changing process of changing the recording area in which the content data is to be recorded, from the recording area of the first layer of the dual-layer recording disk to a recording area of the second layer; and a second layer recording process of recording the second specified data block and a remaining portion of the content data into the recording area of the second layer.

The above object of the present invention can be also achieved by a third recording method of recording encoded content data, which is divided into n data blocks (n is an integer of 2 or more), over two layers of a dual-layer recording disk, the recording method provided with: a first layer recording process of recording a portion of the content data, which is from a head of the content data to the (m−1)-th data block (m is an integer of 1 or more, and m≦n), into an unused area in a recording area of the first layer; a dividing process of dividing the m-th data block into a former portion and a latter portion, forming a first specified data block by using the former portion of the m-th data block, and forming a second specified data block by using the latter portion of the m-th data block such that a tail position of the former portion of the m-th data block matches a tail position of the recording area of the first layer when the m-th data block is recorded from a position which follows the (m−1)-th data block in the unused area in the recording area of the first layer; a dividing/recording process of recording the first specified data block from a position which follows the (m−1)-th data block in the unused area in the recording area of the first layer; a layer changing process of changing the recording area in which the content data is to be recorded, from the recording area of the first layer of the dual-layer recording disk to a recording area of the second layer; and a second layer recording process of recording the second specified data block and a remaining portion of the content data into the recording area of the second layer.

The above object of the present invention can be also achieved by a fourth recording method of recording encoded content data, which is divided into n data blocks (n is an integer of 2 or more), over two layers of a dual-layer recording disk, the recording method provided with: a dummy data block inserting process of inserting a dummy data block between the (j−1)-th data block and the j-th data block (j is an integer of 1 or more and j≦n), and which is expected to be recorded over the layers of the dual-layer recording disk when the content data is recorded into an unused area in a recording area of the first layer of the dual-layer recording disk; a first layer recording process of recording a portion of the content data, into which the dummy data block is inserted and which is from a head of the content data to the dummy data block, into the unused area in the recording area of the first layer; a layer changing process of changing the recording area in which the content data is to be recorded, from the recording area of the first layer of the dual-layer recording disk to a recording area of the second layer; and a second layer recording process of recording a remaining portion of the content data into the recording area of the second layer.

The above object of the present invention can be also achieved by a fifth recording method of recording encoded content data, which is divided into n data blocks (n is an integer of 2 or more), over two layers of a dual-layer recording disk, the recording method provided with: a data block selecting process of selecting the k-th data block (k is an integer of 1 or more, and k<n) such that Bj is equal to or less than A and that a length obtained by subtracting Bj from A is minimal if a length of the unused area in the recording area of the first layer is A and a length between the head of the content data and a tail of the n cells is Bj (j=1, 2, . . . , k−1, k, k+1, . . . , n−1, n); and a recording method selecting process of performing the recording method comprising: a recording start position determining process of determining a recording start position of the content data in an unused area in a recording area of the first layer such that a tail position of the k-th data block (k is an integer of 1 or more, and k<n), counted from a head of the content data, matches a tail position of the recording area of the first layer when the content data is recorded into the unused area in the recording area of the first layer of the dual-layer recording disk; a layer changing device for changing the recording area in which the content data is to be recorded, from the recording area of the first layer of the dual-layer recording disk to a recording area of the second layer; and a second layer recording device for recording the second specified data block and a remaining portion of the content data into the recording area of the second layer mentioned above, if a difference C between a length Bk, which is from a head of the content data to a tail of the k-th data block, and the length A is equal to or less than a predetermined length, and of performing the recording method comprising: a first layer recording process of recording a portion of the content data, which is from a head of the content data to the (m−1)-th data block (m is an integer of 1 or more, and m≦n), into an unused area in a recording area of the first layer; a dividing process of dividing the m-th data block into a former portion and a latter portion, forming a first specified data block by using the former portion of the m-th data block, and forming a second specified data block by using the latter portion of the m-th data block such that a tail position of the former portion of the m-th data block matches a tail position of the recording area of the first layer when the m-th data block is recorded from a position which follows the (m−1)-th data block in the unused area in the recording area of the first layer; a dividing/recording process of recording the first specified data block from a position which follows the (m−1)-th data block in the unused area in the recording area of the first layer; a layer changing process of changing the recording area in which the content data is to be recorded, from the recording area of the first layer of the dual-layer recording disk to a recording area of the second layer; and a second layer recording process of recording the second specified data block and a remaining portion of the content data into the recording area of the second layer mentioned above, if the difference C is greater than the predetermined length.

The above object of the present invention can be also achieved by a sixth recording method of recording encoded content data, which is divided into n data blocks (n is an integer of 2 or more), over two layers of a dual-layer recording disk, the recording method provided with; a data block selecting process of selecting the k-th data block (k is an integer of 1 or more, and k<n) such that Bj is equal to or less than A and that a length obtained by subtracting Bj from A is minimal if a length of the unused area in the recording area of the first layer is A and a length between the head of the content data and a tail of the n cells is Bj (j=1, 2, . . . , k−1, k, k+1, . . . , n−1, n); and a recording method selecting process of performing the recording method comprising; a recording start position determining process of determining a recording start position of the content data in an unused area in a recording area of the first layer such that a tail position of the k-th data block (k is an integer of 1 or more, and k<n), counted from a head of the content data, matches a tail position of the recording area of the first layer when the content data is recorded into the unused area in the recording area of the first layer of the dual-layer recording disk; a layer changing device for changing the recording area in which the content data is to be recorded, from the recording area of the first layer of the dual-layer recording disk to a recording area of the second layer; and a second layer recording device for recording the second specified data block and a remaining portion of the content data into the recording area of the second layer mentioned above, if a difference C between a length Bk, which is from a head of the content data to a tail of the k-th data block, and the length A is equal to or less than a predetermined length, and of performing the recording method comprising: a dividing process of dividing the m-th data block (m is an integer of 1 or more, and m≦n) into a former portion and a latter portion, forming a first specified data block by using the former portion of the m-th data block, and forming a second specified data block by using the latter portion of the m-th data block such that a tail position of the former portion of the m-th data block, counted from a head of the content data, matches a tail position of a recording area of the first layer when the content data is recorded into an unused area in the recording area of the first layer of the dual-layer recording disk; a first layer recording process of recording a portion of the content data, which is from the head of the content data to the (m−1)-th data block, and the first specified data block into the unused area in the recording area of the first layer; a layer changing process of changing the recording area in which the content data is to be recorded, from the recording area of the first layer of the dual-layer recording disk to a recording area of the second layer; and a second layer recording process of recording the second specified data block and a remaining portion of the content data into the recording area of the second layer mentioned above, if the difference C is greater than the predetermined length.

The above object of the present invention can be also achieved by each of first to third computer program for making a computer function as respective one of the first to third recording apparatus of the present invention (including its various aspects).

The above object of the present invention can be also achieved by each of first to third computer program products in a computer-readable medium for tangibly embodying a program of instructions executable by a computer, to make the computer function as respective one of the first to third recording apparatuses of the present invention (including its various aspects).

According to each of the computer program products of the present invention, the aforementioned first to third recording apparatuses of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, each of the computer program products may include computer readable codes to cause the computer (or may comprise computer readable instructions for causing the computer) to function as respective one of the aforementioned first to third recording apparatuses of the present invention.

These effects and other advantages of the present invention will become more apparent from the following embodiments.

### BRIEF DESCRIPTION OF DRAWINGS

FIG. 1 is a block diagram showing a recording/reproducing apparatus in a first embodiment of the present invention.

FIG. 2 is a flowchart showing a dubbing process on the recording/reproducing apparatus in FIG. 1.

FIG. 3 is a flowchart showing a first recording process in the dubbing process in FIG. 2.

FIG. 4 is a flowchart showing a second recording process in the dubbing process in FIG. 2.

FIG. 5 is an explanatory diagram showing a state in which content data recorded on a hard disk is recorded onto a dual-layer write-once type DVD, by the first recording process in FIG. 3.

FIG. 6 is an explanatory diagram showing a state in which the content data recorded on the hard disk is recorded onto the dual-layer write-once type DVD, by the second recording process in FIG. 4.

FIG. 7 is an explanatory diagram showing a cell dividing process in the second recording process in FIG. 4.

FIG. 8 is a block diagram showing a recording/reproducing apparatus in a second embodiment of the present invention.

FIG. 9 is a flowchart showing the second recording process on the recording/reproducing apparatus in FIG. 8.

FIG. 10 is a block diagram showing a recording/reproducing apparatus in a third embodiment of the present invention.

FIG. 11 is a flowchart showing the first recording process on the recording/reproducing apparatus in FIG. 10.

FIG. 12 is an explanatory diagram showing a state in which the content data recorded on the hard disk is recorded onto the dual-layer write-once type DVD, by the first recording process in FIG. 11.

### DESCRIPTION OF REFERENCE CODES

1, 2, 3 recording/reproducing apparatus
10 dual-layer write-once type DVD
15 encoder
20 recording control device
81 signal processing device
35, 82, 91 system control device

### BEST MODE FOR CARRYING OUT THE INVENTION

Hereinafter, the best mode for carrying out the present invention will be explained in each embodiment in order with reference to the drawings.

### First Embodiment

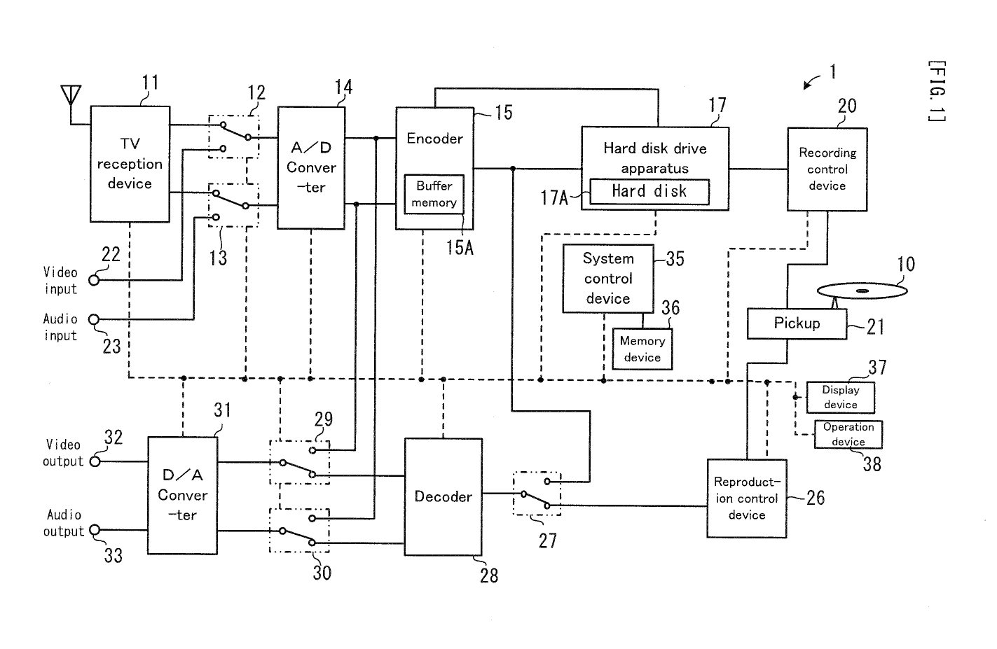

FIG. 1 shows the structure of a recording/reproducing apparatus in a first embodiment of the recording apparatus and the recording method of the present invention. A recording/reproducing apparatus 1 in FIG. 1 can record encoded content data over two layers of a single-sided dual-layer write-once type DVD 10. Specifically, the recording/reproducing apparatus 1 is provided with a hard disk drive apparatus 17, which has a large-capacity (e.g. several tens to several hundreds GB) hard disk 17A, and it can encode the content data, which is received from a TV broadcast station or the like, in accordance with the DVD video standard and record it onto the hard disk 17A. Moreover, the recording/reproducing apparatus 1 can dub or copy the encoded content data, which is recorded on the hard disk 17A, over the two layers of the dual-layer write-once type DVD 10.

With regard to the recording/reproducing apparatus 1 in FIG. 1, the structure and the operation regarding a function of encoding the content data, which is received from the TV broadcast station or the like, and recording it onto the hard disk 17A are as follows. That is, the TV broadcast station transmits an analog video signal and an analog audio signal. A TV reception device 11 receives the video signal and the audio signal, which are transmitted from the TV broadcast station. The video signal and the audio signal are supplied to an A/D converter 14 through input selector switches 12 and 13, and are converted to a digital video signal and a digital audio signal by the A/D converter 14, respectively. Then, an encoder 15 encodes the video signal and the audio signal in accordance with the DVD video standard. The encoded video signal and the encoded audio signal are supplied to the hard disk drive apparatus 17. Then, the hard disk drive apparatus 17 records the encoded video signal and the encoded audio signal, i.e. the encoded content data, onto the hard disk 17A. Incidentally, the recording/reproducing apparatus 1 can record a video signal and an audio signal, which are filmed and recorded by e.g. a video camera, onto the hard disk 17A through external input terminals 22 and 23.

Moreover, with regard to the recording/reproducing apparatus 1, the structure and the operation regarding a function of dubbing the encoded content data, which is recorded on the hard disk 17A, onto the dual-layer write-once type DVD 10 are as follows. The encoded content data, which is recorded on the dual-layer write-once type DVD 10, is supplied to a recording control device 20. The recording control device 20 controls a pickup 21 to record the content data onto the dual-layer write-once type DVD 10. Moreover, in recording the content data onto the dual-layer write-once type DVD 10, the recording control device 20 appends management information to the content data, under the control of a system control device 35.

Moreover, as described later, if a cell dividing process is performed before the content data recorded on the hard disk 17A is recorded onto the dual-layer write-once type DVD 10, one portion of the content data recorded on the hard disk 17A is transferred to the encoder 15, and the cell dividing process is performed on the one portion of the content data on the encoder 15. The one portion of the content data, on which the cell dividing process is performed, is sent back to the hard disk drive apparatus 17 and is recorded onto the hard disk 17A. After this, the content data recorded on the hard disk 17A is supplied to the recording control device 20 and is recorded onto the dual-layer write-once type DVD 10 by the recording control device 20. Incidentally, the recording control device 20 is formed of, e.g., an arithmetic processing circuit, a memory element, and the like.

On the other hand, with regard to the recording/reproducing apparatus 1, the structure and the operation regarding a function of reproducing the content data recorded on the dual-layer write-once type DVD 10 are as follows. The content data recorded on the dual-layer write-once type DVD 10 is read by the pickup 21, under the control of a reproduction control device 26, and is supplied to a decoder 28 through a selector switch 27. The content data is divided into the video signal and the audio signal by the decoder 28, and each signal is decoded. The decoded video signal and the decoded audio signal are supplied to a D/A converter 31 through selector switches 29 and 30, are converted to an analog video signal and an analog audio signal by the D/A converter 31, and are outputted through output terminal 32 and 33, respectively.

The system control device 35 controls each of the constituent elements of the recording/reproducing apparatus 1, such as the TV reception device 11, the A/D converter 14, the encoder 15, the hard disk drive apparatus 17, the recording control device 20, the reproduction control device 26, and the decoder 28. Specifically, the system control device 35 controls the encoder 15, the hard disk drive apparatus 17, the recording control device 20, or the like, to thereby perform a process of dubbing or copying (or a dubbing process) the encoded content data, which is recorded on the hard disk 17A, onto the dual-layer write-once type DVD 10. The system control device 35 is formed of, e.g., an arithmetic processing apparatus, a memory element, and the like. Moreover, the recording/reproducing apparatus 1 is provided with: a memory device 36; a display device 37; and an operation device 38.

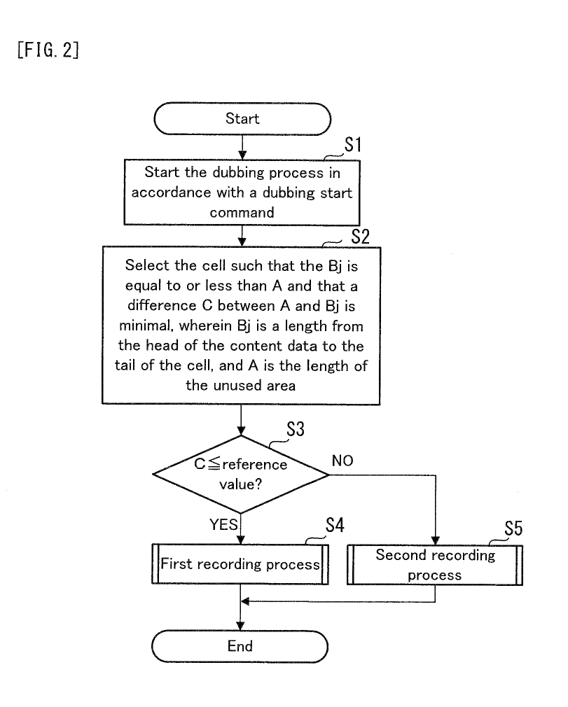

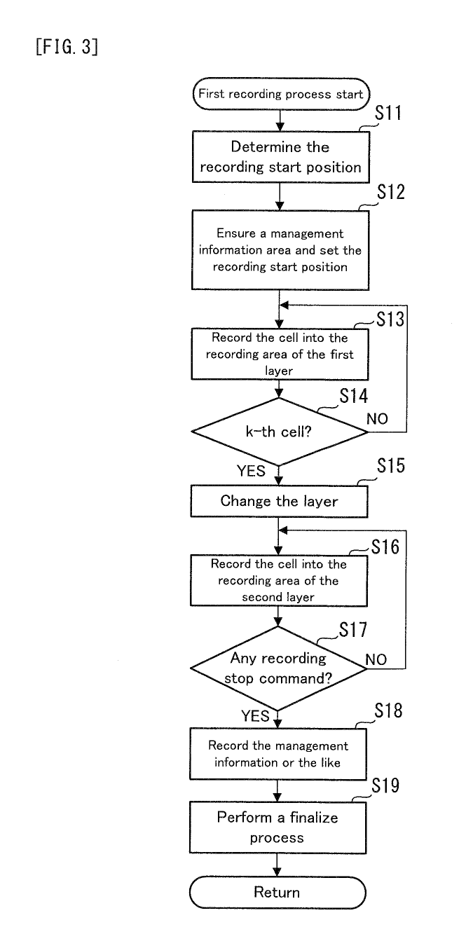

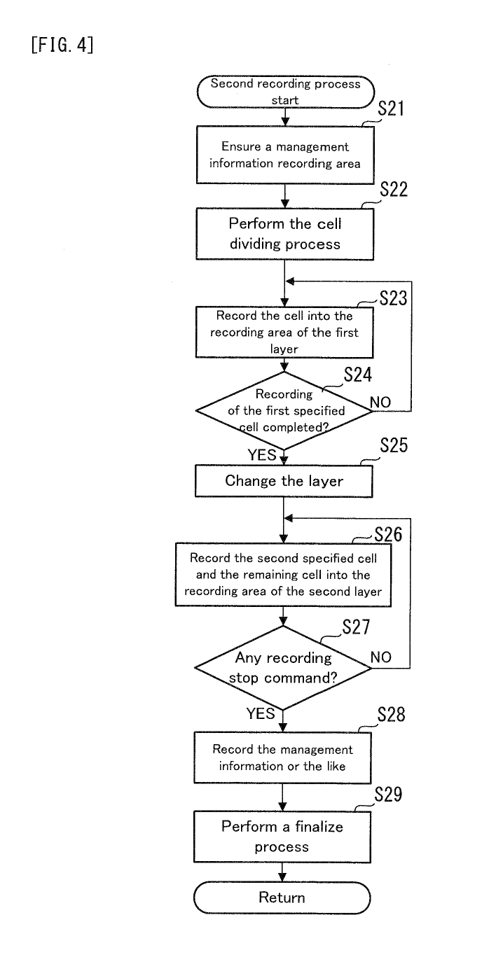

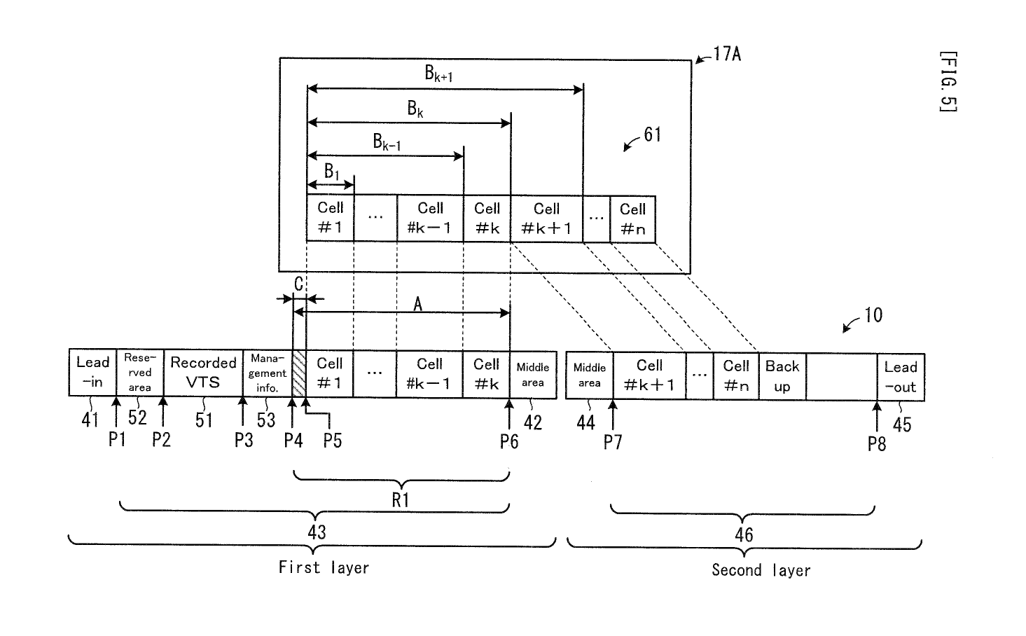

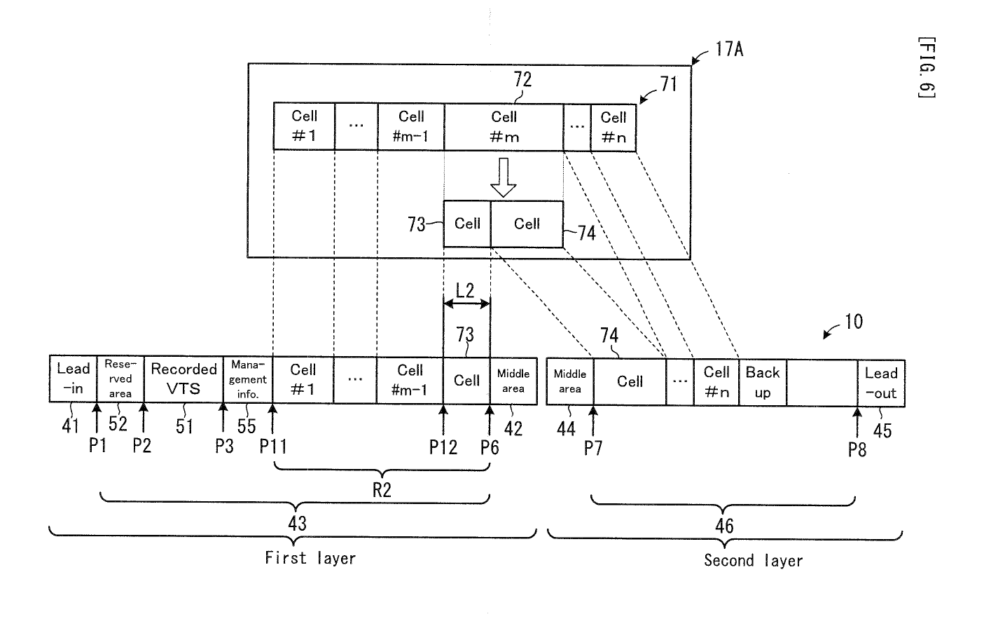

FIG. 2 to FIG. 4 show the content of the dubbing process by the recording/reproducing apparatus 1. Each of FIG. 5 and FIG. 6 shows a state in which the encoded content data is recorded on the dual-layer write-once type DVD 10, by the dubbing process. That is, in the dubbing process, a first recording process (FIG. 3) and a second recording process (FIG. 4) are selectively performed. FIG. 5 shows a state in which the encoded content data recorded on the hard disk 17A is recorded in recording areas 43 and 46 on the dual-layer write-once type DVD 10, by the first recording process. On the other hand, FIG. 6 shows a state in which the encoded content data recorded on the hard disk 17A is recorded in the recording areas 43 and 46 on the dual-layer write-once type DVD 10, by the second recording process. Each of FIG. 5 and FIG. 6 shows the encoded content data (illustrating only the cells) recorded on the hard disk 17A in the upper part, and it shows spiral tracks, formed in the first layer and the second layer of the dual-layer write-once type DVD 10, in such a state that the tracks are linearly elongated from side to side. Moreover, the recording state of the dual-layer write-once type DVD 10 in FIG. 5 and FIG. 6 is the recording stage before a finalize process is performed.

As shown in FIG. 5, the dual-layer write-once type DVD 10 has two recording layers: i.e. the first layer and the second layer. The innermost portion of the first layer is a lead-in area 41, and the outermost portion of the first layer is a middle area 42. In the first layer, there is a recording area 43 between the lead-in area 41 and the middle area 42. The content data, management information (including control information), such as the cell or VOB (Video Object), management information (including control information), such as VTS (Video Title Set), and the like are recorded in the recording area 43. Moreover, the outermost portion of the second layer is a middle area 44, and the innermost portion of the second layer is a lead-out area 45. In the second layer, there is a recording area 46 between the middle area 44 and the lead-out area 45. The content data, the management information, such as the cell or VOB, the management information, such as VTS, and the like are also recorded in the recording area 46. If the dual-layer write-once type DVD 10 is unrecorded, the recording of the content data or the like into the recording area 43 of the first layer on the dual-layer write-once type DVD 10 is progressed from a head position P1 to a tail position P6. Moreover, the recording of the content data or the like into the recording area 46 of the second layer on the dual-layer write-once type DVD 10 is progressed from a head position P7 to a tail position P8. Moreover, the recording of the content data onto the dual-layer write-once type DVD 10 is progressed, normally from the first layer to the second layer.

Now, the dubbing process of the recording/reproducing apparatus 1 is explained. Incidentally, in the explanation below, the case that the content data is additionally recorded (or written once) onto the dual-layer write-once type DVD 10 on which the content data was recorded once in the past and thus one VTS 51 is already recorded in the recording area 43 of the first layer is also exemplified. Moreover, it is assumed that the amount (or length) of the content data which is additionally recorded (or written once) is greater than the length of an unused area R1 (refer to FIG. 5) in the recording area 43 of the first layer of the dual-layer write-once type DVD 10 at a recording start time point. Thus, if it is tried to record the content data onto the dual-layer write-once type DVD 10, the content data is likely recorded over the first layer and the second layer. Moreover, in FIG. 5, a reserved area 52 between the head position P1 to a position P2 in the recording area 43 of the first layer is an area to record therein disk information (e.g. UDF and VMG (Video Manager)) in the finalize process, and it was ensured when the VTS 51 was recorded in the past.

As shown in FIG. 2, for example, a user operates the operation device 38 and inputs a command to start the dubbing process to the recording/reproducing apparatus 1. In response to this, the system control device 35 starts the dubbing process (step S1).

Then, the system control device 35 selects the k-th cell which satisfies the following condition, from among the encoded content data. That is, as shown in FIG. 5 (or FIG. 6), encoded content data 61 (71), which is recorded on the hard disk 17A and which is a dubbing process target, is divided into n cells (n is an integer of 2 or more). Moreover, the unused area R1 in the recording area 43 of the first layer of the dual-layer write-once type DVD 10 has a length of A. Moreover, the length between the head of the content data 61 (71) and the tail of the n-th cell is Bj (j=1, 2, . . . , k−1, k, k+1, . . . , n−1, n). In this case, the system control device 35 selects the k-th cell (k is an integer of 1 or more and k<n) such that Bj is equal to or less than A and that a length obtained by subtracting Bj from A is minimal (step S2). Incidentally, the unrecorded area denotes an unrecorded area other than the area that is ensured to record the data subsequently. Then, the unused area. R1 in the recording area 43 of the first layer denotes an area obtained by eliminating the area in which the management information about the content data (e.g. VTSI (Video Title Set Information), which will be recorded onto the dual-layer write-once type DVD 10 from now, is actually recorded (between a position P3 in FIG. 5 and immediately before a position P4), from the unrecorded area of the recording area 43 before the dubbing process is started.

Then, the system control device 35 judges whether or not a difference C between a length Bk and the length A is equal to or less than a predetermined length L1, wherein the length Bk is between the head of the content data 61 (71) and the tail of the k-th cell (step S3). If the difference C is equal to or less than the predetermined length L1, the system control device 35 performs the first recording process shown in FIG. 3 (step S4). On the other hand, if the difference C is greater than the predetermined length L1, the system control device 35 performs the second recording process shown in FIG. 4 (step S5).

In the first recording process, as shown in FIG. 5, a recording start position P5 of the content data 61 in the unused area R1 in the recording area 43 of the first layer is determined such that the tail position of a k-th cell 62 in the content data 61 matches the tail position P6 of the recording area 43 of the first layer when the content data 61 is recorded into the unused area R1 in the recording area 43 of the first layer of the dual-layer write-once type DVD 10. Then, the recording of the content data 61 is started from the recording start position P5. That is, the tail position of the k-th cell 62 is set to the tail position P6 of the recording area 43 of the first layer by adjusting the recording start position P5 of the content data 61 in the unused area R1 in the recording area 43 of the first layer. According to the first recording process, it is possible to prevent the cell from being recorded over the layers, and it is also possible to prevent the unrecorded area from being formed in the tail area of the recording area 43 of the first layer.

However, in order to appropriately perform the first recording process, there needs to be one cell or the arrangement of cells having the length that is contained in the unused area in the recording area 43 of the first layer, at the head of the content data 61 (71). Moreover, even if there is one cell or the arrangement of cells at the head of the content data 61 (71), a useless area is formed widely in the recording area 43 after the dubbing process if the length between the head position P4 of the unused area R1 and the recording start position P5 is greater than the predetermined length L1 as a result that the recording start position P5 in the unused area R1 of one cell or the arrangement of cells is determined such that the tail position of one cell or the arrangement of cells matches the tail position P6 of the recording area 43 of the first layer. Thus, in the dubbing process, the first recording process is performed only if the length between the head position P4 of the unused area R1 and the recording start position P5 is equal to or less than the predetermined length L1. Then, the second recording process is performed if the length between the head position P4 of the unused area R1 and the recording start position P5 is greater than the predetermined length L1.

In the second recording process, as shown in FIG. 6, a m-th cell 72 is divided into a former portion and a latter portion, a cell 73 (or first specified cell) is formed by using the former portion of the m-th cell 72, and a cell 74 (or second specified cell) is formed by using the latter portion of the m-th cell 72 such that the tail position of the former portion of the m-th cell 72 (m is an integer of 1 or more and m≦n) in the content data 71 matches the tail position P6 of the recording area 43 of the first layer when the content data 71 is recorded from a head position P11 in an unused area R2 in the recording area 43 of the first layer. Then, the cell 73 is recorded into an unused area in the tail area of the recording area 43 of the first layer, and the cell 74 is recorded from the head position P7 of the recording area 46 of the second layer. That is, the m-th cell 72, which will be recorded over the layers if the content data 71 is recorded as it is from the head position P11 of the unused area R2 of the recording area 43 of the first layer, is divided into the two cells 72 and 73 on the basis of a border line of the layers, i.e. the tail position P6 of the recording area 43 of the first layer, and each cell is disposed in respective one of the tail area of the recording area 43 of the first layer and the head area of the recording area 46 of the second layer. Even by the second recording process, it is possible to prevent the cell from being recorded over the layers, and it is also possible to prevent the unrecorded area from being formed in the tail area of the recording area 43 of the first layer.

As described above, according to the dubbing process of the recording/reproducing apparatus 1, it is possible to use the recording area of the dual-layer write-once type DVD without waste and efficiently, by selectively performing the first recording process and the second recording process. Thus, it is possible to increase the amount of data that can be actually recorded onto the dual-layer write-once type DVD 10.

Incidentally, the content data 61 in FIG. 5 is an example in which the length between the head position P4 of the unused area R1 and the recording start position P5 is equal to or less than the predetermined length L1, as a result of the process in the step S2. The content data 71 in FIG. 6 is an example in which the length between the head position P4 of the unused area R1 and the recording start position P5 is greater than the predetermined length L1, as a result of the process in the step S2.

FIG. 3 shows the content of the first recording process (the step S4 in FIG. 2) in the dubbing process. As shown in FIG. 3, if the first recording process is started, firstly, the system control device 35 determines the recording start position P5 of the content data 61 (step S11). That is, the system control device 35 determines the recording start position P5 of the content data 61 in the unused area R1 of the recording area 43 such that the tail position of the k-th cell 62 in the content data 61 matches the tail position P6 of the recording area 43 (more specifically, the end of the last ECC (Error Correction Code) in the recording area 43 of the first layer) when the content data 61 is recorded into the unused area R1 in the recording area 43 of the first layer. Incidentally, the k-th cell 62 is the cell selected in the step S2 in FIG. 2.

Then, under the control of the system control device 35, the recording control device 20 ensures a management information recording area 53 in the recording area 43 of the first layer and sets the recording start position P5 (step S12). That is, the recording control device 20 ensures the management information recording area 53 between the position P3 which follows the area in which the VTS 51 is already recorded in the recording area 43 of the first layer and a position immediately before the recording start position P5. The management information recording area 53 is an area to record therein the management information (e.g. VTSI) about the content data 61 which will be recorded onto the dual-layer write-once type DVD 10. Incidentally, the management information is recorded into the management information recording area 53 after the recording of the content data 61 onto the dual-layer write-once type DVD 10. Therefore, the management information recording area 53 remains unrecorded until the recording of the content data 61 onto the dual-layer write-once type DVD 10 is ended.

Moreover, in the step S12, the recording control device 20 sets the recording start position P5 by adjusting the length of the management information recording area 53. That is, the recording control device 20 sets the recording start position P5 determined in the step S11, by ensuring the management information recording area 53 with its length being greater than that of the management information recorded herein, if necessary. For example, in order to record the management information, it is only necessary to ensure the management information recording area between the position P3 which follows the area in which the VTS 51 is already recorded in the recording area 43 and the position immediately before the position P4. The recording control device 20, however, ensures the management information recording area 53 up to a position immediately before the recording start position P5, which is beyond the position P4, in order to set the recording start position P5.

Then, the recording control device 20 records a portion of the content data 61, which is from the head of the content data 61 to the k-th cell 62, into the unused area R1 in the recording area 43 of the first layer (step S13). That is, the recording control device 20 reads the portion, which is from the head of the content data 61 to the k-th cell 62, from the hard disk 17A, and it records this into the unused area R1 in the recording area 43 of the first layer. The recording of the content data 61 is started from the head position of the unused area R1 of the recording area 43 (or a position which follows the management information recording area 53), i.e. the recording start position P5. Then, the k-th cell 62 is recorded into the tail area of the unused area R1 of the recording area 43. Moreover, the tail position of the k-th cell 62 matches the tail position P6 of the recording area 43.

Then, if the recording of the k-th cell 62 is completed (step S14: YES), the recording control device 20 or the system control device 35 changes the recording area in which the content data 61 is to be recorded, from the recording area 43 of the first layer to the recording area 46 of the second layer (step S15).

Then, the recording control device 20 records a remaining portion of the content data 61 into the recording area 46 of the second layer (step S16). That is, the recording control device 20 substantially reads a portion of the content data 61, which is from the (k+1)-th cell to the n-th cell, from the hard disk 17A, and it starts to record it from the head position P7 of the recording area 46.

If the n-th recording of the content data 61 is completed, a recording stop command is issued from the system control device 35 to the recording control device 20, by which the recording of the content data 61 is ended (step S17: YES).

Then, the recording control device 20 records the management information (e.g. VTSI) into the management information recording area 53. Moreover, the recording control device 20 records backup information about the management information (e.g. VTSI backup information) into an unused area which follows the area in which the last cell is recorded in the recording area 46 of the second layer (step S18). The management information and the backup information are generated by the recording control device 20, under the control of the system control device 35. Moreover, since the length of the management information recording area 53 is greater than the length of the management information, if there is an unrecorded area (i.e. between the position P4 and immediately before the P5) left in the management information recording area 53, the recording control device 20 records data which does not influence the recording and reproduction (e.g. NULL data) into this unrecorded area.

After that, if a finalize process is performed on the dual-layer write-once type DVD 10, the disk information (e.g. UDF information and VMG) is recorded into the reserved area 52 of the first layer, and if there is a remaining unrecorded area in a direction to the tail position P8 in the recording area 46 of the second layer, e.g. NULL data is recorded into this unrecorded area (step S19).

FIG. 4 shows the content of the second recording process (the step S5 in FIG. 2) in the dubbing process. As shown in FIG. 4, if the second recording process is started, firstly, the recording control device 20 ensures a management information recording area 55 in the recording area 43 of the first layer, under the control of the system control device 35 (step S21). That is, the recording control device 20 ensures the management information recording area 55 between the position P3 which follows the area in which the VTS 51 is already recorded in the recording area 43 of the first layer and a position immediately before the recording start position P11. The length of the management information recording area 55 corresponds to the length of the management information (e.g. VTSI) recorded herein.

Then, the cell dividing process is performed (step S22). In the cell dividing process, the m-th cell 72 is divided into the former portion and the latter portion, the cell 73 (or first specified cell) is formed by using the former portion of the m-th cell 72, and the cell 74 (or second specified cell) is formed by using the latter portion of the m-th cell 72 such that the tail position of the former portion of the m-th cell 72 (m is an integer of 1 or more and m≦n) in the content data 71 matches the tail position P6 of the recording area 43 of the first layer when the content data 71 is recorded into the unused area R2 in the recording area 43 of the first layer.

The cell dividing process is performed by the encoder 15. That is, as shown in FIG. 6, in performing the cell dividing process, the system control device 35 firstly specifies the m-th cell 72 from among the content data stored on the hard disk 17A. Specifically, the system control device 35 specifies the m-th cell 72 which will be recorded over the layers if the content data 71 is recorded from the head position P11 of the unused area R2 in the recording area 43 of the first layer. This specification is performed as follows, for example. Firstly, the system control device 35 compares the length of the first cell with that of the unused area R2. If the length of the first cell is less than that of the unused area R2, the system control device 35 integrates the length of the second cell to that of the first cell, and then compares the integrated value with the length of the unused area R2. If the integrated value is less than the length of the unused area R2, the system control device 35 integrates the length of the third cell to the integrated value and again compares the integrated value with the length of the unused area R2. The system control device 35 repeats such integration and comparison. Then, if the integrated value becomes greater than the length of the unused area R2, the system control device 35 specifies the cell that is the last integration target, as the m-th cell 72. Once it specifies the m-th cell 72, then, the system control device 35 transfers the m-th cell 72 from the hard disk 17A to the encoder 15. By this, the m-th cell 72 is developed on a buffer memory 15A of the encoder 15. Then, the encoder 15 performs the cell dividing process on the m-th cell 72 developed on the buffer memory 15A.

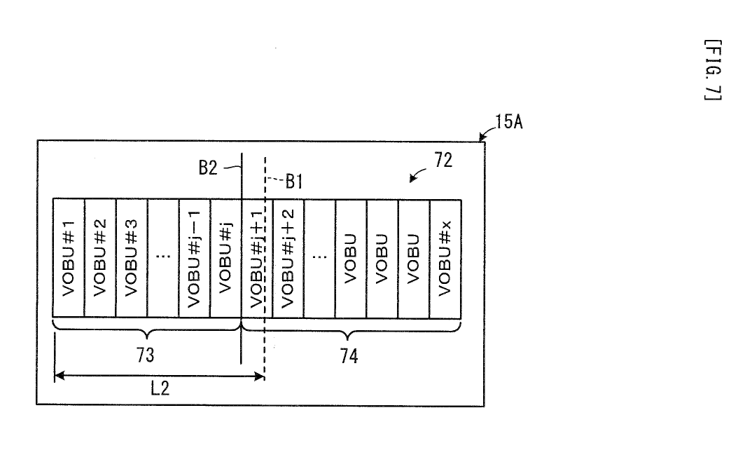

FIG. 7 shows the cell dividing process performed on the m-th cell 72. As shown in FIG. 7, the m-th cell 72, which is transferred to the buffer memory 15A of the encoder 15, is provided with a plurality of VOBUs. The VOBU#1 illustrated on the left side of FIG. 7 is the VOBU disposed at the head of the cell 72. Moreover, the VOBU#x illustrated on the right side of FIG. 7 is the VOBU disposed at the tail of the cell 72. Moreover, a dashed line B1 extending in a longitudinal direction in FIG. 7 corresponds to the border line of the recording area 43 and the middle area 42 in the first layer. In other words, if the cell 72 is recorded in the recording area 43, the VOBU#j+1 above the dashed line B1 is recorded over the border line of the recording area 43 and the middle are 42 in the first layer (incidentally, in this case, since one portion of the VOBU#j+1 intrudes in the middle area 42, such recording is not performed, in reality). Moreover, a solid line B2 extending in the longitudinal direction in FIG. 7 corresponds to a dividing line. The cell 72, which is to be recorded from the tail area of the recording area 43 of the first layer to the head area of the recording area 46 of the second layer, is divided into the former portion and the latter portion by the cell dividing process, with the dividing line B2 on the boundary. Then, the former portion of the cell 72 is recorded into the tail area of the recording area 43 of the first layer, as the cell 73. The latter portion of the cell 72 is recorded into the head area of the recording area 46 of the second layer, as the cell 74.

Specifically, the cell dividing process is performed as follows. As shown in FIG. 6, firstly, the system control device 35 calculates a length L2 of the unused area (between a position P12 and the tail position P6 in FIG. 6) which exists in the tail area of the recording area 43 when the head of the content data 71 to the (m−1)-th cell are recorded from the head position P11 of the unused area R2 in the recording area 43 of the first layer. Then, under the control of the system control device 35, the encoder 15 integrates the lengths of the VOBUs included in the cell 72, which is developed on the buffer memory 15A, one by one from the VOBU#1 to the VOBU#x, as shown in FIG. 7. When the integrated value exceeds the value of the length L2, the encoder 15 stops the integration and specifies the VOBU#j+1, which is the last integration target. By this, it is possible to specify the VOBU#j+1 corresponding to the border line (or dashed line B1) of the recording area 43 and the middle area 42 in the first layer. Then, the encoder 15 sets the dividing line B2 between the VOBU#j+1 and the VOBU#j, and divides the cell 72 into the cell 73 and the cell 74 in accordance with the dividing line B2. Then, the encoder 15 extracts the audio data, which is included in the cell 74 and which is the audio data that is to be synchronized with the video data included in the cell 73, from the cell 74, and puts it into the cell 73. Then, the encoder 15 extracts the audio data which is included in the cell 73 and which is the audio data that is to be synchronized with the video data included in the cell 74, from the cell 73, and puts it into the cell 74. By changing the audio data between the cell 73 and the cell 74, if there is a significant change in the lengths of the cell 73 and the cell 74, the encoder 15 performs again the aforementioned processes of the specification of the VOBU#j+1, the setting of the dividing line, the cell division, and the change of the audio data. Then, the encoder 15 appends an appropriate SCR again to the cell 73 and the cell 74, in view of after the division. Then, the encoder 15 inserts a private packet or the like into the tail portion of the cell 73, to thereby perform ECC alignment on the cell 73.

After the cell dividing process by the encoder 15, the system control device 35 transfers the cells 73 and 74, which are divided by the cell dividing process, from the buffer memory 15A of the encoder 15 to the hard disk 17A.

After the transfer of the cells 73 and 74, the recording control device 20 records the cell 73 and the portion of the content data 71, which is from the head of the content data 71 to the (m−1)-th cell, into the unused area R2 in the recording area 43 of the first layer (step S23 in FIG. 4). That is, the recording control device 20 reads the cell 73 and the portion, which is from the head of the content data 71 to (m−1)-th cell, from the hard disk 17A, and it records them into the unused area R2 in the recording area 43 of the first layer. The recording of the content data 71 is started from the head position P11 of the unused area R2 of the recording area 43 (or a position which follows the management information recording area 55). Then, the recording of the cell 73 is started from the position P12. Moreover, tail position of the cell 73 matches the tail position P6 of the recording area 43.

Then, if the recording of the cell 73 (or first specified cell) is completed (step S24: YES), the recording control device 20 or the system control device 35 changes the recording area in which the content data 71 is to be recorded, from the recording area 43 of the first layer to the recording area 46 of the second layer (step S25).

Then, the recording control device 20 records the cell 74 (or second specified cell) and a remaining portion of the content data 71 into the recording area 46 of the second layer (step S26). That is, the recording control device 20 substantially reads the cell 74 and the portion which follows the cell 74 and which is from the (m+1)-th cell to the n-th cell, from the hard disk 17A, and it starts to record them from the head position P7 of the recording area 46.

If the n-th recording of the content data 71 is completed, a recording stop command is issued from the system control device 35 to the recording control device 20, by which the recording of the content data 71 is ended (step S27: YES).

Then, the recording control device 20 records the management information (e.g. VTSI) into the management information recording area 55. Moreover, the recording control device 20 records the backup information about the management information (e.g. VTSI backup information) into an unused area which follows the area in which the last cell is recorded in the recording area 46 of the second layer (step S28). The management information and the backup information are generated by the recording control device 20, under the control of the system control device 35.

After that, if a finalize process is performed on the dual-layer write-once type DVD 10, the disk information (e.g. UDF information and VMG) is recorded into the reserved area 52 of the first layer, and if there is a remaining unrecorded area in a direction to the tail position P8 in the recording area 46 of the second layer, e.g. NULL data is recorded into this unrecorded area (step S29).

As explained above, in the first recording process in the dubbing process by the recording/reproducing apparatus 1, the tail position of the k-th cell 62 is set to the tail position P6 of the recording area 43 of the first layer by adjusting the recording start position P5 of the content data 61 in the unused area R1 in the recording area 43 of the first layer. By this, it is possible to prevent the cell from being recorded over the layers. Moreover, it is possible to prevent the unrecorded area from being left in the tail area of the recording area 43 of the first layer when a finalize process is performed.

Moreover, in the second recording process in the dubbing process by the recording/reproducing apparatus 1, the m-th cell 72, which will be recorded over the layers if the content data 71 is recorded as it is from the head position P11 of the unused area R2 of the recording area 43 of the first layer, is divided into the two cells 72 and 73 on the basis of the border line of the layers, i.e. the tail position P6 of the recording area 43 of the first layer, and each cell is disposed in respective one of the tail area of the recording area 43 of the first layer and the head area of the recording area 46 of the second layer. By this, it is possible to prevent the cell from being recorded over the layers. Moreover, it is also possible to prevent the unrecorded area from being left in the tail area of the recording area 43 of the first layer when a finalize process is performed.

Therefore, either by the first recording process or by the second recording process, it is possible continuously record the content data over the first layer and the second layer of the dual-layer recording disk in compliance with the DVD video standard.

Moreover, since the cell can be recorded up to the tail position P6 of the recording area 43 of the first layer either by the first recording process or by the second recording process, it is possible to prevent that nothing is displayed on a screen immediately before a layer change, a noise is displayed on the screen, or no sound is produced, when the content data is reproduced.

Moreover, since it is possible to comply with the DVD standard either by the first recording process or by the second recording process, it is possible to provide compatibility with competitors' products with regard to the recording and reproduction of the content data.

Moreover, the first recording process ensures the management information recording area 53, which is to record therein the management information about the content data (e.g. VTSI), between the head position P3 of the unrecorded area R1 in the recording area 43 of the first layer and immediately before the recording start position P5, and it adjusts the length of the management information recording area 53, to thereby set the recording start position P5. By this, it is possible to adjust the recording start position P5 of the VOB in compliance with the DVD video standard.

Moreover, according to the dubbing process of the recording/reproducing apparatus 1, it is possible to use the recording area of the dual-layer write-once type DVD 10 without waste and efficiently, by selectively performing the first recording process and the second recording process. Thus, it is possible to increase the amount of data that can be actually recorded onto the dual-layer write-once type DVD 10.

### Second Embodiment

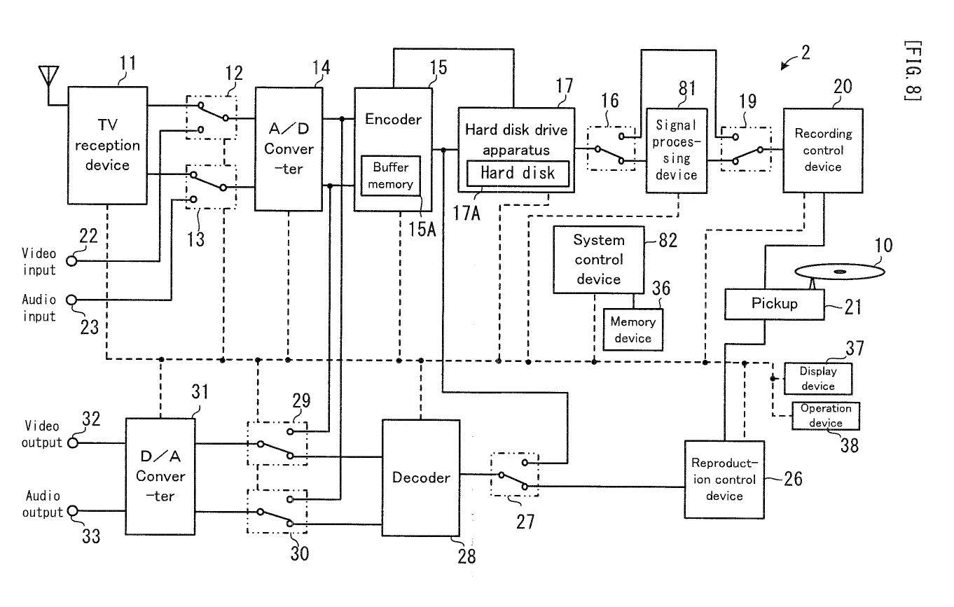

FIG. 8 shows the structure of a recording/reproducing apparatus in a second embodiment of the recording apparatus and the recording method of the present invention. Incidentally, in a recording/reproducing apparatus 2 in the second embodiment, the same constituent elements as those of the recording/reproducing apparatus 1 in FIG. 1 carry the same numerical numbers, and the explanation thereof will be omitted.

On the recording/reproducing apparatus 2 in the second embodiment, a signal processing device 81 is provided between the hard disk drive apparatus 17 and the recording control device 20. The signal processing device 81 performs the cell dividing process in the second recording process in the dubbing process of the recording/reproducing apparatus 2. The signal processing device 81 is formed of, e.g., an arithmetic processing circuit, a memory element, and the like.

A system control device 82 controls each of the constituent elements of the recording/reproducing apparatus 2. Specifically, the system control device 82 controls the hard disk drive apparatus 17, the signal processing device 81, the recording control device 20, or the like, to thereby perform a process of dubbing or copying (or a dubbing process) the encoded content data, which is recorded on the hard disk 17A, onto the dual-layer write-once type DVD 10. The system control device 82 is formed of, e.g., an arithmetic processing apparatus, a memory element, and the like.

In the dubbing process of the recording/reproducing apparatus 2, the content of the second recording process is different from that in the dubbing process of the recording/reproducing apparatus 1 described above. Specifically, in the second recording process of the recording/reproducing apparatus 1, the cell dividing process is performed before the content data is actually recorded onto the dual-layer write-once type DVD 10. In contrast, in the second recording process of the recording/reproducing apparatus 2, the cell dividing process is performed while the content data is actually recorded onto the dual-layer write-once type DVD 10.

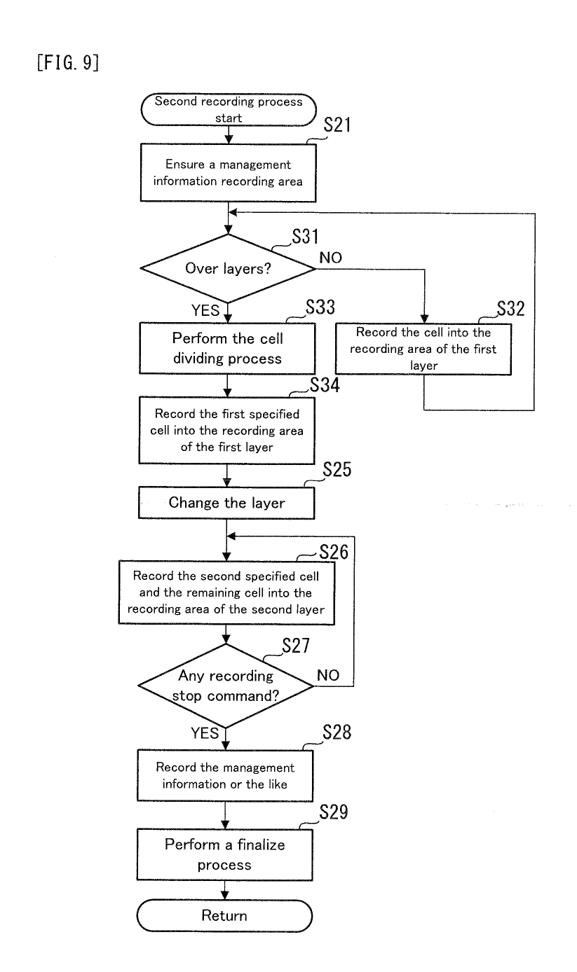

FIG. 9 shows the second recording process in the dubbing process on the recording/reproducing apparatus 2. As shown in FIG. 9, after the recording control device 20 ensures the management information recording area 55, the system control device 82 judges whether or not one cell to be recorded from now will be recorded over the layers of the dual-layer write-once type DVD 10 (step S31). The judgment can be performed by comparing the length of the one cell to be recorded from now with the length of the unused are of the recording area 43 immediately before the relevant cell is recorded.

If the one cell to be recorded from now is not recorded over the layers of the dual-layer write-once type DVD 10 (the step S31: NO), the system control device 82 controls selector switches 16 and 19 to directly connect the hard disk drive apparatus 17 with the recording control device 20 and to supply the cell from the hard disk 17A to the recording control device 20 without through the signal processing device 81. Then, the recording control device 20 records the cell into the recording area 43 (step S32).

On the other hand, if the one cell to be recorded from now is recorded over the layers of the dual-layer write-once type DVD 10 (the step S31: YES), the system control device 82 controls the selector switches 16 and 19 to connect the hard disk drive apparatus 17 with the signal processing device 81 and to connect the signal processing device 81 with the recording control device 20. Then, the system control device 82 supplies the cell from the hard disk 17A to the signal processing device 81 and issues, e.g., a cell dividing command to the signal processing device 81. In response to this, the signal processing device 81 performs the cell dividing process on the cell, to thereby divide the cell into the former portion and the latter portion, form the first specified cell by using the former portion of the cell, and form the second specified cell by using the latter portion of the cell (step S33). The content of the cell dividing process is the same as that in the step S22 in FIG. 4. (refer to FIG. 7).

Then, the recording control device 20 records the first specified cell from a position which follows the area in which the previous cell is recorded in the recording area 43 (step S34). By this, the cell is recorded up to the tail position of the recording area 43 of the first layer.

Then, the process after the step S25 in the second recording process shown in FIG. 4 is performed.

As explained above, even by the recording/reproducing apparatus 2, as in the recording/reproducing apparatus 1, it is possible to prevent the cell from being recorded over the layers, and it is possible to prevent the unrecorded area from being formed in the tail area of the recording area 43 of the first layer. Therefore, it is possible continuously record (or dub) the content data over the first layer and the second layer of the dual-layer recording disk in compliance with the DVD video standard. Moreover, it is possible to prevent that nothing is displayed on a screen immediately before a layer change, a noise is displayed on the screen, or no sound is produced, when the content data is reproduced. Moreover, since it is possible to comply with the DVD standard, it is possible to provide compatibility with competitors' products with regard to the recording and reproduction of the content data.

### Third Embodiment

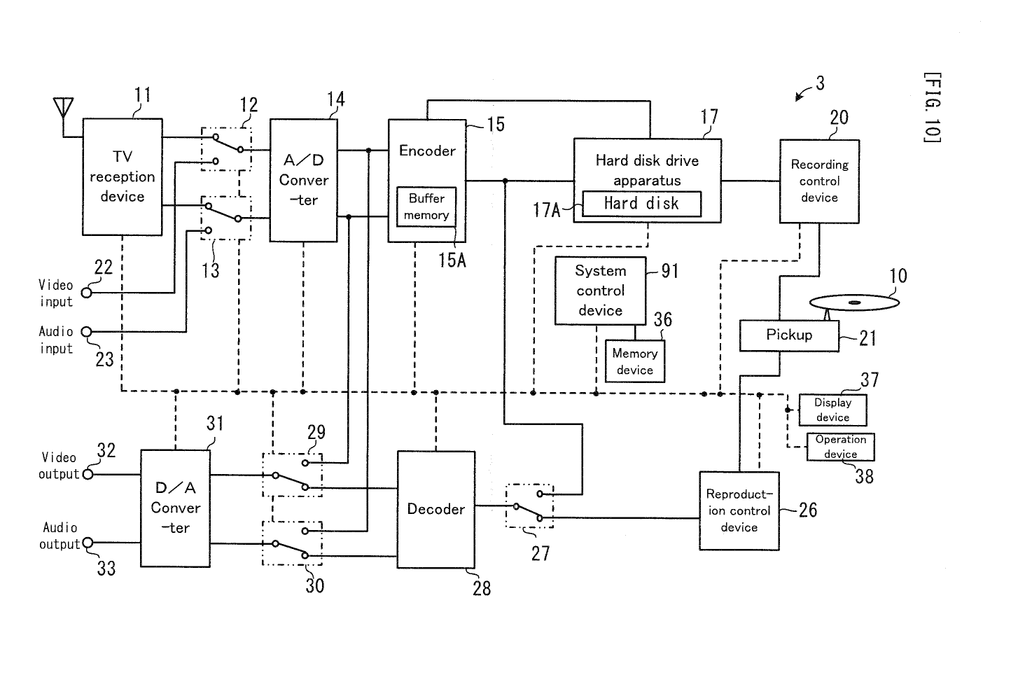

FIG. 10 shows the structure of a recording/reproducing apparatus in a third embodiment of the recording apparatus and the recording method of the present invention. Incidentally, in a recording/reproducing apparatus 3 in the third embodiment, the same constituent elements as those of the recording/reproducing apparatus 1 in FIG. 1 carry the same numerical numbers, and the explanation thereof will be omitted.

A signal processing device 91 of the recording/reproducing apparatus 3 in the third embodiment controls each of the constituent elements of the recording/reproducing apparatus 3. Specifically, the system control device 91 controls the hard disk drive apparatus 17, the recording control device 20, or the like, to thereby perform a process of dubbing or copying (or a dubbing process) the encoded content data, which is recorded on the hard disk 17A, onto the dual-layer write-once type DVD 10. The system control device 91 is formed of, e.g., an arithmetic processing apparatus, a memory element, and the like.

In the dubbing process of the recording/reproducing apparatus 3, the content of the first recording process is different from that in the dubbing process of the recording/reproducing apparatus 1 described above. Specifically, in the first recording process of the recording/reproducing apparatus 1, the tail position of the last cell, which is recorded in the recording area 43 of the first layer, is set to the tail position of the recording area 43 by adjusting the recording start position of the content data in the unused area in the recording area 43 of the first layer. In contrast, in the first recording process of the recording/reproducing apparatus 3, a j-th cell, which will be recorded over the layers if the content data is recorded as it is from the head position of the unused area of the recording area 43 of the first layer, is recorded from the head area of the recording area 46 of the second layer, and dummy data is inserted between a position which follows the tail of the (j−1)-th cell and the tail position of the recording area 43 of the first layer.

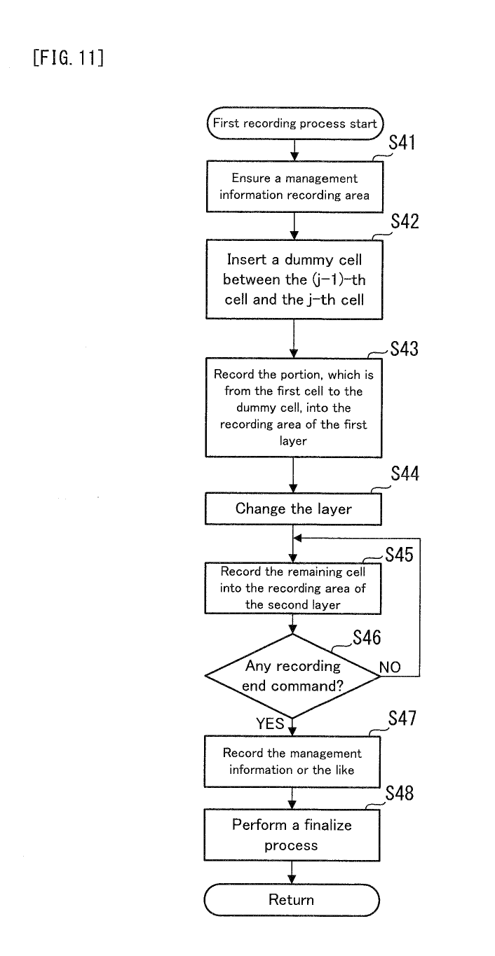

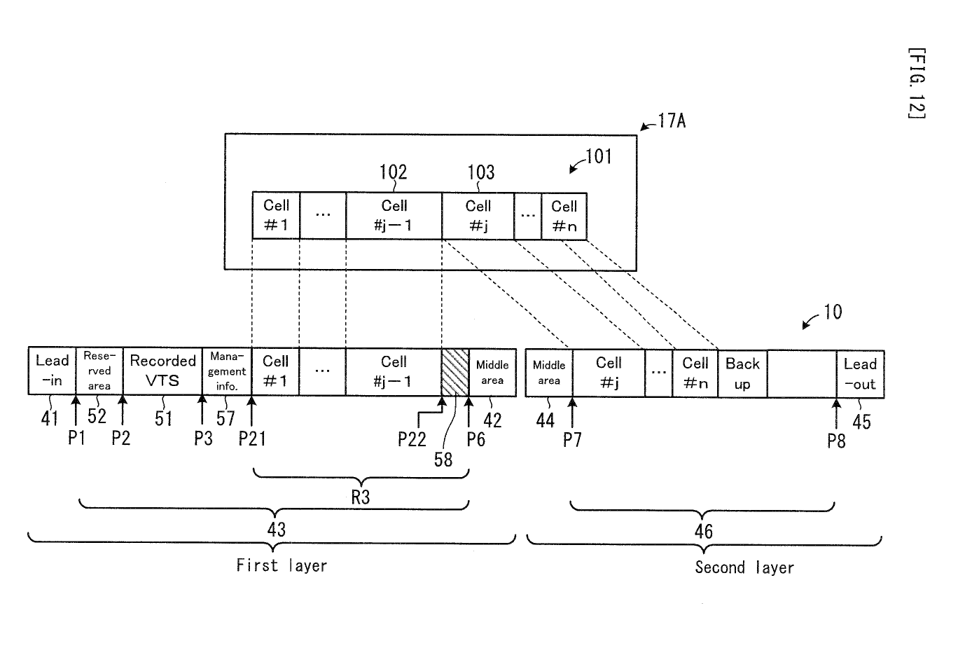

FIG. 11 shows the first recording process in the dubbing process on the recording/reproducing apparatus 3. Moreover, FIG. 12 shows a state in which the encoded content data is recorded on the dual-layer write-once type DVD 10, by the first recording process.

As shown in FIG. 11, firstly, the recording control device 20 ensures a management information recording area 57 in the recording area 43 of the first layer, under the control of the system control device 91 (step S41). The length of the management information recording area 57 corresponds to the length of the management information (e.g. VTSI) recorded herein.

Then, the system control device 91 inserts a dummy cell between the (j−1)-th cell and the j-th cell (j is an integer of 1 or more, and j≦n), which is expected to be recorded over the layers of the dual-layer write-once type DVD 10 when the content data is recorded into an unused area R3 (or an area between a position P21 in FIG. 12 and the position P6) in the recording area 43 of the first layer of the dual-layer write-once type DVD 10 (step S42).

That is, as shown in FIG. 12, the system control device 91 firstly specifies the j-th cell 103 from among the content data 101 stored on the hard disk 17A. The specification is performed as follows. Firstly, the system control device 91 compares the length of the first cell with the length of the unused area R3. If the length of the first cell is less than the length of the unused area R3, then the system control device 91 integrates the length of the second cell to that of the first cell, and then compares the integrated value with the length of the unused area R3. If the integrated value is less than the length of the unused area R3, the system control device 91 integrates the length of the third cell to the integrated value and again compares the integrated value with the length of the unused area R3. The system control device 91 repeats such integration and comparison. Then, if the integrated value becomes greater than the length of the unused area R3, the system control device 91 specifies the cell that is the last integration target, as the j-th cell 103.

After specifying the j-th cell 103, the system control device 91 determines the length of the dummy cell to be inserted into the content data 101. The length of the dummy cell is set to be substantially equal to the length between a position P22 which follows the tail position of the (j−1)-th cell 102 and the tail position P6 of the recording area 43 of the first layer when the head of the content data 101 to the (j−1)-th cell 102 are recorded from the head position P21 of the unused area R3 in the recording area 43 of the first layer.

After determining the length of the dummy cell, the system control device 91 generates the dummy cell. The dummy cell is generated by using, e.g., one or more VOBUs which constitute the head cell of the content data 101 recorded on the hard disk 17A. Specifically, the system control device 91 copies one or more VOBUs from the head cell of the content data 101 recorded on the hard disk 17A, appends the SCRs of the VOBUs again, and establishes the dummy cell by using the VOBUs. Moreover, in the tail portion of the dummy cell established in this manner, the ECC alignment is performed by inserting the private packet or the like. Incidentally, the VOBU (or dummy data) used to establish the dummy cell may be stored in a ROM or the like to be held separately by the recording/reproducing apparatus 3.

After generating the dummy cell, the system control device 91 inserts the dummy cell between the (j−1)-the cell and the j-th cell of the content data 101 recorded on the hard disk 17A.

Then, the recording control device 20 records the portion of the content data 101, which is from the head of the content data 101 to the dummy cell, into the unused area R3 of the recording area 43 of the first layer (step S43). The recording of the content data 101 is started from a head position of the unused area R3 in the recording area 43 (or a position which follows the management information recording area 57), i.e. the recording start position P21. Then, the dummy cell is recorded into a tail area 58 of the unused area R3 of the recording area 43. The tail position of the dummy cell matches the tail position P6 of the recording area 43.

Then, the recording control device 20 or the system control device 91 changes the recording area in which the content data 101 is to be recorded, from the recording area 43 of the first layer to the recording area 46 of the second layer (step S44).

Then, the recording control device 20 records a remaining portion of the content data 101, i.e. the cells after the j-th cell, into the recording area 46 of the second layer (step S45).

If the n-th recording of the content data 101 is completed, a recording stop command is issued from the system control device 91 to the recording control device 20, by which the recording of the content data 101 is ended (step S46: YES).

Then, the recording control device 20 records the management information (e.g. VTSI) into the management information recording area 57. Moreover, the recording control device 20 records the backup information about the management information (e.g. VTSI backup information) into an unused area which follows the area in which the last cell is recorded in the recording area 46 of the second layer (step S47).

After that, if a finalize process is performed on the dual-layer write-once type DVD 10, the disk information (e.g. UDF information and VMG) is recorded into the reserved area 52 of the first layer, and if there is a remaining unrecorded area in a direction to the tail position P8 in the recording area 46 of the second layer, e.g. NULL data is recorded into this unrecorded area (step S48).

Incidentally, the dummy cell is defined to be the cell that is not referred to from a PGC (Program Chain). By this, the inserted dummy cell is not reproduced.

As explained above, even by the recording/reproducing apparatus 3, as in the recording/reproducing apparatus 1, it is possible to prevent the cell from being recorded over the layers, and it is also possible to prevent the unrecorded area from being formed in the tail area of the recording area 43 of the first layer. Therefore, it is possible continuously record (or dub) the content data over the first layer and the second layer of the dual-layer recording disk in compliance with the DVD video standard. Moreover, it is possible to prevent that nothing is displayed on a screen immediately before a layer change, a noise is displayed on the screen, or no sound is produced, when the content data is reproduced. Moreover, since it is possible to comply with the DVD standard, it is possible to provide compatibility with competitors' products with regard to the recording and reproduction of the content data.

Incidentally, each of the recording/reproducing apparatuses 1 to 3 is provided with the hard disk drive apparatus as the recording apparatus having the large-capacity recording medium; however, the recording apparatus having the large-capacity recording medium is not limited to the hard disk drive apparatus. For example, it may be a rewritable type or write-once type optical disk.

Moreover, the aforementioned explanation exemplifies the dubbing process as an example in which the encoded content data is recorded over the first layer and the second layer of the dual-layer recording disk. The present invention is not limited to this. For example, the present invention can be applied to the case that the encoded content data, which is transmitted from a digital TV broadcast station, is received and recorded over the first layer and the second layer of the dual-layer write-once type DVD. Moreover, the present invention can be applied to the case that the encoded content data, which is outputted to a digital video camera or digital AV equipment, is recorded over the first layer and the second layer of the dual-layer write-once type DVD.

Moreover, it is exemplified that each of the aforementioned recording/reproducing apparatuses 1 to 3 records the content data onto the dual-layer write-once type DVD 10. The present invention, however, can be also applied not only to the dual-layer write-once type DVD but also to a dual-layer rewritable type DVD (e.g. a dual-layer DVD-RW or the like).

Moreover, the recording apparatus and the recording method of the present invention are not limited to the AV equipment, such as a hard disk drive built-in type DVD recorder, and they can be also applied to other equipment for industrial use, medical use, educational use, or household use, which has a function of recording the video information and the audio information.

Moreover, the recording apparatus and the recording method of the present invention can be also realized by making a computer read a computer program. In this case, a computer program is prepared to realize the functions of the recording start position determining device, the first layer recording device, the layer changing device, the second layer recording device, the dividing device, or the like, by using a hardware resource which is provided in advance for the computer or which is connected to the computer.

Moreover, in the present invention, various changes may be made, if desired, without departing from the essence or spirit of the invention which can be read from the claims and the entire specification. A recording apparatus, a recording method, and a computer program which realizes these functions, all of which involve such changes, are also intended to be within the technical scope of the present invention.

### INDUSTRIAL APPLICABILITY

The recording apparatus and the recording method for dual-layer recording disk according to the present invention can be applied to a recording apparatus, such as a DVD recorder, which records the content data onto an optical disk having two recording layers, such as a DVD.

1-18. (canceled)

19. A recording apparatus for recording encoded content data, which is divided into n data blocks (n is an integer of 2 or more), over two layers of a dual-layer recording disk, said recording apparatus comprising:
a data block selecting device for selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a dividing device for dividing the (k+1)-th data block into a former portion and a latter portion, forming a first specified data block by using the former portion of the (k+1)-th data block, and forming a second specified data block by using the latter portion of the (k+1)-th data block such that a tail position of the former portion of the (k+1)-th data block matches a tail position of the recording area of the first layer if a difference C between a length Bk, which is from the head of the content data to a tail of the k-th data block, and the length A is greater than a predetermined length;
a first layer recording device for recording a portion of the content data, which is from the head of the content data to the k-th data block, and the first specified data block into the unused area in the recording area of the first layer;
a layer changing device for changing the recording area in which the content data is to be recorded, from the recording area of the first layer to a recording area of a second layer of the dual-layer recording disk; and
a second layer recording device for recording the second specified data block and a remaining portion of the content data into the recording area of the second layer.

20. A recording apparatus for recording encoded content data, which is divided into n data blocks (n is an integer of 2 or more), over two layers of a dual-layer recording disk, said recording apparatus comprising:
a data block selecting device for selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a recording start position determining device for determining a recording start position of the content data in the unused area in the recording area of the first layer such that a tail position of the k-th data block matches a tail position of the recording area of the first layer if a difference C between a length Bk, which is from the head of the content data to a tail of the k-th data block, and the length A is equal to or less than a predetermined length;
a first layer recording device for recording a portion of the content data, which is from the head of the content data to the k-th data block, from the recording start position in the unused area in the recording area of the first layer;
a layer changing device for changing the recording area in which the content data is to be recorded, from the recording area of the first layer to a recording area of a second layer of the dual-layer recording disk; and
a second layer recording device for recording a remaining portion of the content data into the recording area of the second layer.

21. The recording apparatus according to claim 20, wherein said first layer recording device comprises a recording start position setting device for setting the recording start position by adjusting a length of a management information recording area, which is ensured immediately before the unused area in the recording area of the first layer in order to record management information as for the content data.

22. A recording apparatus for recording encoded content data, which is divided into n data blocks (n is an integer of 2 or more), over two layers of a dual-layer recording disk, said recording apparatus comprising:
a data block selecting device for selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a dummy data block inserting device for inserting a dummy data block between the k-th data block and the (k+1)-th data block if a difference C between a length Bk, which is from the head of the content data to a tail of the k-th data block, and the length A is equal to or less than a predetermined length;
a first layer recording device for recording a portion of the content data, into which the dummy data block is inserted and which is from the head of the content data to the dummy data block, into the unused area in the recording area of the first layer;
a layer changing device for changing the recording area in which the content data is to be recorded, from the recording area of the first layer to a recording area of a second layer of the dual-layer recording disk; and
a second layer recording device for recording a remaining portion of the content data into the recording area of the second layer.

23. The recording apparatus according to claim 22, wherein a length of the dummy data block is substantially equal to a length between a position which follows a tail position of the k-th data block and a tail position of the recording area of the first layer when the head of the content data to the k-th data block are recorded into the unused area in the recording area of the first layer.

24. The recording apparatus according to claim 19, wherein the data block is a cell in a DVD video standard.

25. The recording apparatus according to claim 20, wherein the data block is a cell in a DVD video standard.

26. The recording apparatus according to claim 22, wherein the data block is a cell in a DVD video standard.

27. A recording method of recording encoded content data, which is divided into n data blocks (n is an integer of 2 or more), over two layers of a dual-layer recording disk, said recording method comprising:
a data block selecting process of selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a dividing process of dividing the (k+1)-th data block into a former portion and a latter portion, forming a first specified data block by using the former portion of the (k+1)-th data block, and forming a second specified data block by using the latter portion of the (k+1)-th data block such that a tail position of the former portion of the (k+1)-th data block matches a tail position of the recording area of the first layer if a difference C between a length Bk, which is from the head of the content data to a tail of the k-th data block, and the length A is greater than a predetermined length;
a first layer recording process of recording a portion of the content data, which is from the head of the content data to the k-th data block, and the first specified data block into the unused area in the recording area of the first layer;
a layer changing process of changing the recording area in which the content data is to be recorded, from the recording area of the first layer to a recording area of a second layer of the dual-layer recording disk; and
a second layer recording process of recording the second specified data block and a remaining portion of the content data into the recording area of the second layer.

28. A recording method of recording encoded content data, which is divided into n data blocks (n is an integer of 2 or more), over two layers of a dual-layer recording disk, said recording method comprising:
a data block selecting process of selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n)
a first layer recording process of recording a portion of the content data, which is from the head of the content data to the k-th data block, into the unused area in the recording area of the first layer if a difference C between a length Bk, which is from the head of the content data to a tail of the k-th data block, and the length A is greater than a predetermined length;
a dividing process of dividing the (k+1)-th data block into a former portion and a latter portion, forming a first specified data block by using the former portion of the (k+1)-th data block, and forming a second specified data block by using the latter portion of the (k+1)-th data block such that a tail position of the former portion of the (k+1)-th data block matches a tail position of the recording area of the first layer when the (k+1)-th data block is recorded from a position which follows the k-th data block in the unused area in the recording area of the first layer;
a dividing/recording process of recording the first specified data block from a position which follows the k-th data block in the unused area in the recording area of the first layer;
a layer changing process of changing the recording area in which the content data is to be recorded, from the recording area of the first layer to a recording area of a second layer of the dual-layer recording disk; and
a second layer recording process of recording the second specified data block and a remaining portion of the content data into the recording area of the second layer.

29. A recording method of recording encoded content data, which is divided into n data blocks (n is an integer of 2 or more), over two layers of a dual-layer recording disk, said recording method comprising:
a data block selecting process of selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a recording start position determining process of determining a recording start position of the content data in an unused area in a recording area of the first layer such that a tail position of the k-th data block matches a tail position of the recording area of the first layer if a difference C between a length Bk, which is from the head of the content data to a tail of the k-th data block, and the length A is equal to or less than a predetermined length;
a first layer recording process of recording a portion of the content data, which is from the head of the content data to the k-th data block, from the recording start position in the unused area in the recording area of the first layer;
a layer changing process of changing the recording area in which the content data is to be recorded, from the recording area of the first layer to a recording area of a second layer of the dual-layer recording disk; and
a second layer recording process of recording a remaining portion of the content data into the recording area of the second layer.

30. A recording method of recording encoded content data, which is divided into n data blocks (n is an integer of 2 or more), over two layers of a dual-layer recording disk, said recording method comprising:
a data block selecting process of selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a dummy data block inserting process of inserting a dummy data block between the k-th data block and the (k+1)-th data block if a difference C between a length Bk, which is from the head of the content data to a tail of the k-th data block, and the length A is equal to or less than a predetermined length;
a first layer recording process of recording a portion of the content data, into which the dummy data block is inserted and which is from a head of the content data to the dummy data block, into the unused area in the recording area of the first layer;
a layer changing process of changing the recording area in which the content data is to be recorded, from the recording area of the first layer to a recording area of a second layer of the dual-layer recording disk; and
a second layer recording process of recording a remaining portion of the content data into the recording area of the second layer.

31. A computer program product for making a computer function as a recording apparatus for recording encoded content data, which is divided into n data blocks (n is an integer of 2 or more), over two layers of a dual-layer recording disk, said recording apparatus comprising:
a data block selecting device for selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a dividing device for dividing the (k+1)-th data block into a former portion and a latter portion, forming a first specified data block by using the former portion of the (k+1)-th data block, and forming a second specified data block by using the latter portion of the (k+1)-th data block such that a tail position of the former portion of the (k+1)-th data block matches a tail position of the recording area of the first layer if a difference C between a length Bk, which is from the head of the content data to a tail of the k-th data block, and the length A is greater than a predetermined length;
a first layer recording device for recording a portion of the content data, which is from the head of the content data to the k-th data block, and the first specified data block into the unused area in the recording area of the first layer;
a layer changing device for changing the recording area in which the content data is to be recorded, from the recording area of the first layer to a recording area of a second layer of the dual-layer recording disk; and
a second layer recording device for recording the second specified data block and a remaining portion of the content data into the recording area of the second layer.

32. A computer program product for making a computer function as a recording apparatus for recording encoded content data, which is divided into n data blocks (n is an integer of 2 or more), over two layers of a dual-layer recording disk, said recording apparatus comprising:
a data block selecting device for selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a recording start position determining device for determining a recording start position of the content data in the unused area in the recording area of the first layer such that a tail position of the k-th data block matches a tail position of the recording area of the first layer if a difference C between a length Bk, which is from the head of the content data to a tail of the k-th data block, and the length A is equal to or less than a predetermined length;
a first layer recording device for recording a portion of the content data, which is from the head of the content data to the k-th data block, from the recording start position in the unused area in the recording area of the first layer;
a layer changing device for changing the recording area in which the content data is to be recorded, from the recording area of the first layer to a recording area of a second layer of the dual-layer recording disk; and
a second layer recording device for recording a remaining portion of the content data into the recording area of the second layer.

33. A computer program product for making a computer function as a recording apparatus for recording encoded content data, which is divided into n data blocks (n is an integer of 2 or more), over two layers of a dual-layer recording disk, said recording apparatus comprising:
a data block selecting device for selecting the k-th data block (k is an integer of 1 or more, and k<n) such that Bj is equal to or less than A and that a length obtained by subtracting Bj from A is minimal if a length of an unused area in a recording area of a first layer of the dual-layer recording disk is A and a length between a head of the content data and a tail of the n data blocks is Bj (j=1, 2, . . . , n−1, n);
a dummy data block inserting device for inserting a dummy data block between the k-th data block and the (k+1)-th data block if a difference C between a length Bk, which is from the head of the content data to a tail of the k-th data block, and the length A is equal to or less than a predetermined length;
a first layer recording device for recording a portion of the content data, into which the dummy data block is inserted and which is from the head of the content data to the dummy data block, into the unused area in the recording area of the first layer;
a layer changing device for changing the recording area in which the content data is to be recorded, from the recording area of the first layer to a recording area of a second layer of the dual-layer recording disk; and
a second layer recording device for recording a remaining portion of the content data into the recording area of the second layer.
